(19) United States
(12) Patent Application Publication
(10) Pub. No.: US 2020/0269357 A1
(43) Pub. Date: Aug. 27, 2020

(54) LASER PROCESSING DEVICE AND LASER PROCESSING METHOD

(71) Applicant: Panasonic Intellectual Property Management Co., Ltd., Osaka (JP)

(72) Inventors: TAKESHI OMORI, Osaka (JP); KAZUKI FUJIWARA, Osaka (JP); TAKAYUKI ATEGI, Osaka (JP); YOSHIRO KITAMURA, Osaka (JP)

(21) Appl. No.: 16/776,929

(22) Filed: Jan. 30, 2020

(30) Foreign Application Priority Data
Feb. 22, 2019 (JP) 2019-030351

(51) Int. Cl. B23K 26/53; B23K 26/082; B23K 26/03

(52) U.S. Cl. CPC B23K 26/53; B23K 26/03; B23K 26/082

(57) ABSTRACT

To reduce a width of a modified layer and suppress positional variation of the modified layer, a crystal orientation of a workpiece is measured, a vertical direction with respect to an A-plane of the measured crystal orientation of the workpiece is specified, and a polarization direction of laser light is adjusted so that scanning of laser light is performed along the specified vertical direction with respect to the A-plane of the crystal orientation of the workpiece.

### TECHNICAL FIELD

The technical field relates to a laser processing device and a laser processing method for processing brittle materials such as gallium nitride (GaN) as workpieces.

### BACKGROUND

Manufacture of substrates (wafers) using silicon (Si) and the like as materials has been performed in the past as follows. First, a cylindrical ingot solidified while being pulled up from a molten silicon melt in a quartz crucible is fabricated. Subsequently, the ingot is cut into blocks with proper lengths and ground to have a target shape and diameter. After that, the block-shaped ingot is sliced by a wire saw to manufacture the substrates.

However, at the time of slicing by the wire saw, a material loss is large because a cutting margin larger than a wire diameter is necessary due to the wire diameter, a warp of wire or the like, which leads to a problem of extreme difficulty to manufacture substrates with a thickness of 0.1 mm or less. It is difficult to perform processing particularly incases of using hard brittle materials such as GaN, silicon carbide (SiC) and sapphire as compared with the case of using Si; furthermore, the cutting margin is increased as it is difficult to cut a thin substrate.

Additionally, the effect of the material loss produced on costs of substrates is large as materials are high in costs; therefore, it is necessary to reduce costs of substrates by increasing the number of substrates which can be manufactured from one ingot.

### SUMMARY

There has been known a substrate processing device in which a condensation point of laser light is allowed to focus on the inside of the ingot, namely, a workpiece by a condensing lens, and the workpiece is relatively scanned by the laser light to form a modified layer inside a crystal, then, part of the workpiece is peeled off as a substrate using the modified layer as a peel-off surface. It has been also known that optimization of irradiation power, a feeding speed and an irradiation pitch as well as correction of a condensing position due to a refractive index of the crystal are performed at the time of forming the modified layer inside the crystal by irradiating the surface of crystal with laser to thereby reduce a width and suppress positional variations in the modified layer (for example, refer to JP-A-2013-161976 (Patent Literature 1) and JP-A-2016-201575 (Patent Literature 2).

However, even when the optimization of irradiation power, the feeding speed and the irradiation pitch as well as the correction of the condensing position due to the refractive index of the crystal are performed, effects in reduction of the width and suppression in positional variations in the modified layer formed inside the workpiece have been insufficient.

An object of the present disclosure is to reduce the width and to suppress positional variations in the modified layer.

A laser processing device according to the present disclosure performing processing of a workpiece by applying condensed laser light at least includes a crystal orientation measurement unit configured to measure a crystal orientation of the workpiece, a polarization plane adjustment unit configured to adjust a polarization plane of the laser light and a vertical direction specifying unit configured to specify a vertical direction with respect to an A-plane of the crystal orientation of the workpiece, in which the polarization plane adjustment unit adjusts a polarization direction of the laser light so that scanning of laser light is performed along the specified vertical direction with respect to the A-plane of the crystal orientation of the workpiece.

In the laser processing device according to the present disclosure, the crystal orientation measurement unit may measure the crystal orientation on a surface of the workpiece irradiated with the laser light.

In the laser processing device according to the present disclosure, the laser light may have a wavelength of 1100 nm or less, a pulse width of 1 fsec or more to 1 nsec or less, a frequency of 2 MHz or less, and numerical aperture of a lens for condensing laser light may be 0.4 or more to 0.95 or less.

In the laser processing device according to the present disclosure, gallium nitride may be processed as the workpiece.

A laser processing device according to the present disclosure performing processing of a workpiece by applying condensed laser light at least includes a polarization plane adjustment unit configured to adjust a polarization plane of the laser light and a vertical direction specifying unit configured to specify a vertical direction with respect to an A-plane of a crystal orientation of the workpiece based on a measured crystal orientation of the workpiece, in which the polarization plane adjustment unit adjusts a polarization direction of the laser light so that scanning of laser light is performed along the specified vertical direction with respect to the A-plane of the crystal orientation of the workpiece.

A laser processing method according to the present disclosure performing processing of a workpiece by applying condensed laser light at least includes the steps of measuring a crystal orientation of the workpiece, adjusting a polarization plane of the laser light, and specifying a vertical direction with respect to an A-plane of the measured crystal orientation of the workpiece, in which, in the step of adjusting the polarization plane, a polarization direction of the laser light is adjusted so that scanning of laser light is performed along the specified vertical direction with respect to the A-plane of the crystal orientation of the workpiece.

A laser processing method according to the present disclosure performing processing of a workpiece by applying condensed laser light at least includes the steps of adjusting a polarization plane of the laser light, and specifying a vertical direction with respect to an A-plane of a crystal orientation of the workpiece based on a measured crystal orientation of the workpiece, in which, in the step of adjusting the polarization plane, a polarization direction of the laser light is adjusted so that scanning of laser light is performed along the specified vertical direction with respect to the A-plane of the crystal orientation of the workpiece.

According to the present disclosure, it is possible to reduce the width and to suppress positional variations in the modified layer.

### BRIEF DESCRIPTION OF THE DRAWINGS

FIG. 1 is a view for explaining an example of a sliding process in manufacture of GaN substrates;

FIG. 2 is a graph showing the relationship of a width of a modified layer, positional variations in modification and a laser power density;

FIG. 3 is a view showing an example of a structure of a related-art laser processing device;

FIG. 4 is a view showing an example of a structure of a laser processing device according to an embodiment of the present disclosure;

FIG. 5 is a view showing a scanning method of laser light in the laser processing device according to the embodiment of the present disclosure;

FIG. 6 is a flowchart showing a crystal orientation measurement process according to the embodiment of the present disclosure;

FIG. 7 is a flowchart showing a laser processing process according to the embodiment of the present disclosure;

FIG. 8 is a view showing an image of a scanning direction of laser light with respect to an A-plane of a crystal orientation according to the embodiment of the present disclosure;

FIG. 9 is a view showing a scanning method of laser light by the laser processing device according to another embodiment of the present disclosure.

FIG. 10 is a view showing an image of a scanning direction of laser irradiation with respect to the A-plane of the crystal orientation according to another embodiment of the present disclosure; and

FIG. 11 is a view showing a formation state of the modified layer after the laser processing.

### DESCRIPTION OF EMBODIMENTS

An explanation will be made with respect an embodiment using GaN as a workpiece; however, the workpiece is not limited to this. For example, Si, SiC, sapphire and so on can be considered as other workpieces. Also in the embodiment, a GaN wafer with 2 inches in diameter and 400 μm in thickness is used; however, the wafer is not limited by the diameter or the thickness, and a thick bulk material or the like may be used. In a workpiece (ingot) 301, mirror finish is applied to at least a surface on which laser light is incident, and the workpiece 301 has a transmittance of at least 80% or more with respect to visible light.

Prior to the explanation of the embodiment of the present disclosure, a slicing process in manufacture of GaN wafers, the relationship of a width of a modified layer, positional variations in modification and a laser power density and a related-art laser processing device will be explained.

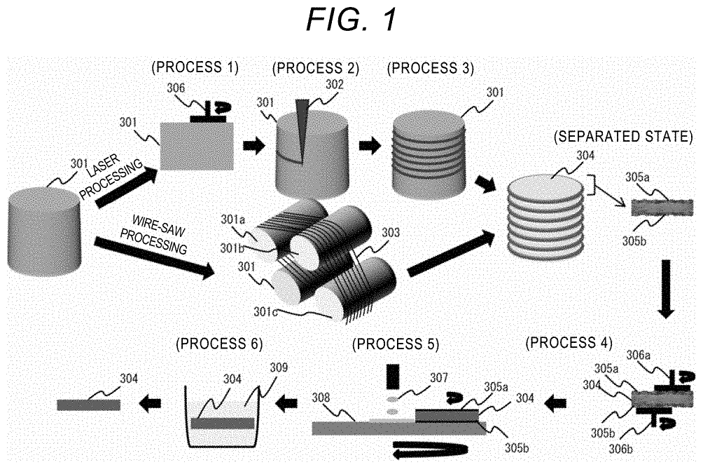

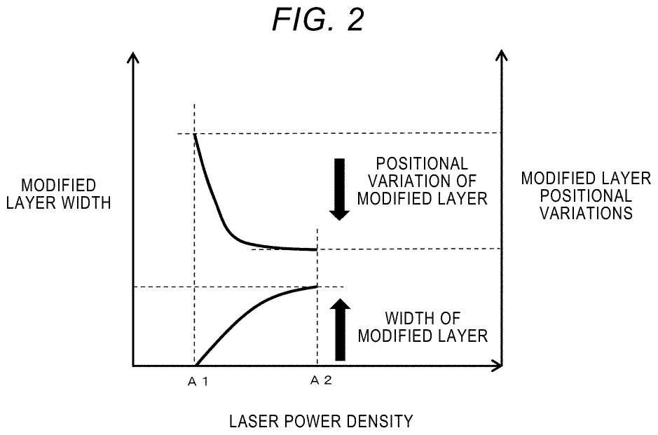

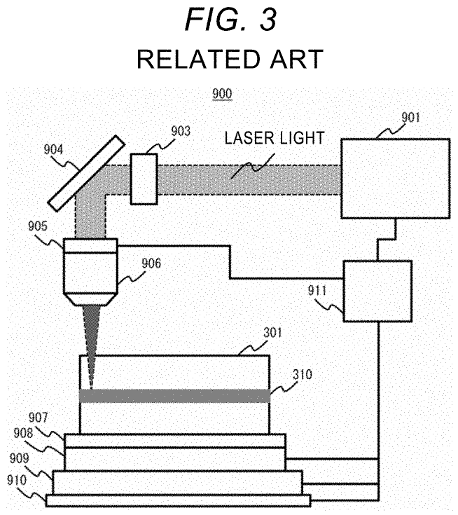

FIG. 1 is a view for explaining an example of the sliding process in manufacture of GaN wafers. FIG. 2 is a graph showing the relationship of the width of the modified layer, positional variations in modification and the laser power density. FIG. 3 is a view showing an example of a structure of a related-art laser processing device.

### (Slicing Process in Manufacture of GaN Substrates)

First, the slicing process in manufacture of GaN substrates will be explained with reference to FIG. 1.

The slicing process is a process of manufacturing a plurality of GaN wafers 304 with a prescribed thickness by sliding an ingot 301 as a lump of GaN. As examples slicing processing in the slicing process, laser processing and wire-saw processing are known.

In laser processing, first, a surface of the ingot 301 is polished to a level in which a laser 302 for processing is transmitted by a rough polishing wheel 306 (a process 1).

Subsequently, internal processing of a crystal of the ingot 301 is performed to the polished ingot 301 by the laser 302 for processing (a process 2).

Subsequently, the ingot 301 to which the internal processing has been performed is separated into a plurality of GaN wafers 304 by a separator (a process 3).

On the other hand, the ingot 301 can be separated by using one or plural wires 303 into a plurality of GaN wafers 304 in the wire-saw processing.

On a surface of each GaN wafer 304 separated by the sliding process, altered layers 305a and 305b are formed. Thicknesses of the altered layers 305a and 305b are extremely thick layers, which are 30 to 50 μm in the laser processing and 50 to 100 μm in the wire-saw processing (in a separated state).

Accordingly, the surface of the GaN wafer 304 is roughly polished by rough polishing wheels 306a and 306b until respective thicknesses of the altered layers 305a and 305b become several (a process 4). This process is performed to both surfaces of the GaN wafer 304.

Subsequently, a CMP (chemical mechanical polishing) process is performed for completely removing the altered layers 305a and 305b which have been roughly polished (a process 5). In this process, the CMP is performed to the GaN wafer 304 in which the altered layers 305a and 305b still remain on surfaces by using a slurry 306 on a CMP surface plate 308. This process is performed to both surfaces of the GaN wafer 304.

Lastly, the GaN wafer 304 to which the CMP has been performed is cleaned by a cleaning solution 309 to complete the GaN wafer (a process 6).

The laser processing device and a laser processing method according to the present disclosure are applied to (the process 2) in the above-described layer processing.

### (Problems in Related-Art Laser Processing)

Here, problems in the related-art laser processing are mentioned. Even when optimization of irradiation power of the laser for processing, optimization of a moving speed and an irradiation pitch of the laser for processing, and correction of a condensing position of laser light by a refractive index of the crystal of the workpiece are performed, the reduction of the width and suppression in positional variations in the modified layer formed inside the workpiece have not been sufficient in the past.

FIG. 2 is the graph showing the relationship of the width of the modified layer, positional variations in modification and the laser power density.

The graph shows the relationship of the width of the modified layer formed inside the workpiece, positional variations in modification and the laser power density applied to the condensing position, namely, laser power per a unit time or/and a unit speed.

It is found from the graph that the modified layer is generated at a threshold value A1 of the laser power density, and the width of the modified layer is increased until reaching a threshold value A2 together with increase of the laser power density. When the laser power density is increased to the threshold value A2, a crack or a break may occur in the wafer.

Also from the graph, it is found that positional variations of the modified layer are large when the laser power density is small, reducing with the increase of the laser power density to be smallest at the threshold A2.

According to the above, the width of the modified layer and the positional variations of the modified layer have a trade-off relationship, and the crack or the break occurs more easily particularly in a case of processing a workpiece in which a cleavage direction of the crystal differs from a forming direction of the modified layer as in GaN. Accordingly, it is extremely difficult to find conditions satisfying the both.

On the other hand, correction of the condensing position of laser light by the refractive index of the wafer is limited to correction of the condensing position corresponding to a difference in incident angles on the workpiece between a central part and a peripheral part of laser light. Accordingly, an effect produced on positional variations of the modified layer and an effect produced on occurrence of the crack or the break attributed to the crystal are not sufficient yet though the correction is effective for suppressing the width of the modification layer in the workpiece.

### (Structure of Related-Art Laser Processing Device)

Next, a related-art laser processing device will be explained. FIG. 3 is a view showing an example of a structure of the related-art laser processing device.

In the drawing, 301 denotes an ingot as a workpiece and 310 denotes a modified layer. The modified layer 310 is a layer formed inside the ingot 301 when the laser light is condensed and applied to the ingot 301, which is, for example, a layer resolved as 2GaN→2Ga+N2 by irradiation of laser light in the case where the material is GaN.

A related-art laser processing device 900 includes a laser oscillator 901 from which laser light is emitted (oscillates), a phase modulator 903 controlling a branch, a shape and a waveform of laser light, a mirror 904 reflecting laser light, a lens position adjustment unit 905, a condensing lens 906, a fixing jig 907, a rotation stage 908, a Z-stage 909, an XY-stage 910 and a control unit 911.

As it is difficult to adjust a polarization plane and a polarization direction of laser light in the related-art laser processing device 900, laser processing is performed without considering the polarization plane of laser light with respect to a crystal orientation of the ingot 301.

### (Structure of Laser Processing Device of Present Disclosure)

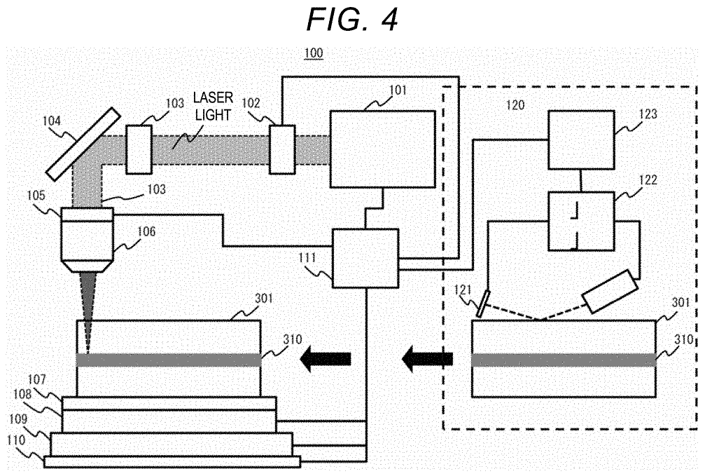

Hereinafter, a laser processing device of the present disclosure will be explained. FIG. 4 is a view showing an example of a structure of the laser processing device according to an embodiment of the present disclosure.

Referring to FIG. 4, a laser processing device 100 according to the present disclosure includes a laser oscillator 101, a phase modulator 103, a mirror 104, a lens position adjustment unit 105, a condensing lens 106, a fixing jig 107, a rotation stage 108, a Z-stage 109, an XY-stage 110, a laser processing controller 111 and a crystal orientation measurement unit 120 having a detector section 121, a crystal orientation measurement controller 122 and a data storing section 123.

The laser oscillator 101 is an apparatus from which laser light oscillates (is emitted). Effective laser processing can be performed by selecting a laser wavelength in consideration of transmittance with respect to each workpiece. Oscillating laser light has a wavelength in which 80% of the laser light is transmitted through GaN as the ingot 301. The wavelength is 532 nm and pulse oscillation with the maximum repetition frequency of 1 MHz can be performed, in which the maximum output is 100 W and a pulse width is 25 ps or less.

A polarization plane adjustment unit 102 is for adjusting an angle of the polarization plane of oscillating laser light by transmitting or reflecting the laser light, capable of holding the polarization plane at a certain fixed angle or capable of changing the angle of the polarization plane with time. As the angle of polarization plane can be adjusted by the polarization plane adjustment unit 102, the polarization direction of the polarization plane can be changed. As the polarization plane adjustment unit 102, for example, an electro-optic modulator (EO modulator) can be cited; however, the polarization plane adjustment unit 102 is not limited to this.

The phase modulator 103 is for allowing the laser light transmitted through or reflected on the polarization plane adjustment unit 102 to branch into plural beams or for changing the shape or the waveform of the beams. As the phase modulator 103, for example, a diffraction grating can be cited; however, the phase modulator 103 is not limited to this.

The mirror 104 is for reflecting laser light transmitted through the phase modulator 103, having a reflectance of 90% or more with respect to the wavelength of the laser.

The lens position adjustment unit 105 is an apparatus for varying the condensing lens 106 at high speed. It is preferable that the apparatus uses the electro-optic modulator or an acoustic-optical element capable of switching at high speed due to a high frequency. For example, there is a method of varying displacement so as to correspond to processing using the apparatus by using the acoustic-optical element.

The condensing lens 106 is for condensing laser light reflected on the mirror 104 and applying the laser light to the inside of the ingot. The condensing lens 106 is a material transmitting laser light, capable of correcting the laser light to the optimum aberration amount in accordance with a processing depth. In the embodiment, a 100× objective lens of NA=0.85, f=2 mm with an aberration correction collar for a microscope that transmits a wavelength of 532 nm is used.

The fixing jig 107 is a jig for fixing the ingot 301. As the fixing jig 107, for example, a jig having a function of fixing the ingot 301 by sandwiching side surfaces thereof, a jig having a function of fixing ingot 301 by adhesion, a jig having a function of performing vacuum suction and so on can be considered.

The rotation stage 108 is arranged below the fixing jig 107, which can vary at a rotation speed in a range from 0.1 rpm or more to 5000 rpm or less.

The Z-stage 109 is arranged below the rotation stage 108, which is one of driving means used for processing the entire surface of the ingot 301. In the Z-state 109, the accuracy is 1 μm and a stroke in a Z-direction is 10 mm.

The XY-stage 110 is arranged below the Z-stage 109, which is one of driving means used for processing the entire surface of the ingot 301. In the XY-stage 110, the accuracy is 1 μm and strokes in X and Y direction are both 200 mm. The XY-stage 110 can vary at a scanning speed in a range from 0.1 mm/sec or more to 3 mm/sec or less.

The laser processing controller 111 is for controlling the laser processing device 100. The laser processing controller 111 performs ON/OFF control of oscillation of laser light from the laser oscillator 101, control in the angle adjustment of the polarization plane by the polarization plane adjustment unit 102, and control in variations of the condensing lens 106 by the lens position adjustment unit 105.

The laser processing controller 111 also controls respective stages of the rotation stage 108, the Z-stage 109 and the XY stage 110 in synchronization with the angle of the polarization plane adjusted by the polarization plane adjustment unit 102 and variations of the condensing lens 106 by the lens position adjustment unit 105. The laser processing controller 111 performs laser processing by allowing the polarization plane adjustment unit 102 to be synchronized with the XY stage 110 based on crystal orientation measurement data stored in the data storing section 123 in the later-described crystal orientation measurement unit 120.

The crystal orientation measurement unit 120 is for measuring a crystal orientation of the ingot 301, which is formed by the detector section 121, the crystal orientation measurement controller 122 and the data storing section 123. As the crystal orientation measurement unit 120, for example, an XRD (X-ray diffractometer) that measures a crystal orientation by a method using X-ray diffraction can be cited; however, the crystal orientation measurement unit 120 is not limited to this.

The detector section 121 is for measuring position coordinates of the surface of the ingot 301, namely, data of the crystal orientation with respect to X, Y coordinates.

The data storage section 123 is for storing the position coordinates of the surface of the ingot 301 measured by the detector section 121, namely, data of the crystal orientation with respect to X, Y coordinates.

The crystal orientation measurement controller 122 is for controlling the crystal orientation measurement unit 120, performing control of crystal orientation measurement by the detector section 121, processing of storing the measured crystal orientation data in the data storage section 123, and processing of transmitting the crystal orientation data stored in the data storage section 123 to the laser processing controller 111.

In the present embodiment, the structure of the laser processing device 100 is supposed to include the crystal orientation measurement unit 120; however, the structure is not limited to this. For example, it is possible to apply a structure in which the laser processing device 100 does not include the crystal orientation measurement unit 120. According to such structure, crystal orientation data measured and stored by a crystal orientation measurement device (not shown) including the crystal orientation measurement unit 120 is registered in the laser processing controller 111 manually or automatically, and laser processing in which the polarization plane adjustment unit 102 is synchronized with the XY-stage 110 can be achieved as described above by using the registered crystal orientation data.

The structure of the laser processing device 100 according to the present disclosure has been explained above. The most characteristic difference between the laser processing device 100 according to the present disclosure and the related-art laser processing device 900 is the presence of the polarization plane adjustment unit 102. That is, it was difficult to adjust the polarization plane and the polarization direction of laser light in the related-art laser processing device 900.

### (Scanning Method of Laser Light)

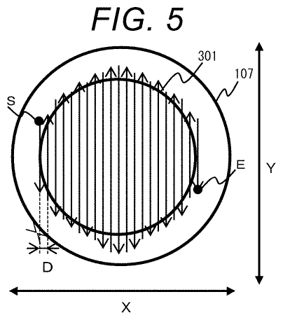

FIG. 5 is a view showing a scanning method of laser light in the laser processing device according to the embodiment of the present disclosure.

FIG. 5 shows the scanning method used when linear scanning is performed with laser light by using the XY stage 110. In the drawing, a width D shows a pitch between respective lines in a case where linear scanning is performed with the laser light by moving the XY stage 110. A start point S indicates an irradiation start position of laser light and an end point E indicates an irradiation end position of laser light.

First, the linear scanning is performed on a straight line (Y-direction) in a forward direction by irradiation of laser light by linear movement of the XY stage 110. Subsequently, after the XY stage 110 moves in an X direction by the width D with respect to the previous scanning, the XY stage 110 linearly moves in a reverse direction to the previous scanning direction, thereby performing scanning on the straight line (Y-direction) with the laser light in a reverse direction to the previous scanning. After that, the operation is repeated until the laser light reaches the end point E, thereby performing laser processing on the entire surface of the ingot 301.

It is necessary to forma continuous modified layer on the ingot 301 for removing gas from the modified layer 310 formed on an outer edge part of the ingot 301 at the time of laser processing. In such case, a formation amount of the modified layer 310 is changed by the scanning speed of laser light, the laser power, intervals between pulses changing in accordance with the frequency, and variation of the width D.

### (Crystal Orientation Measurement Process)

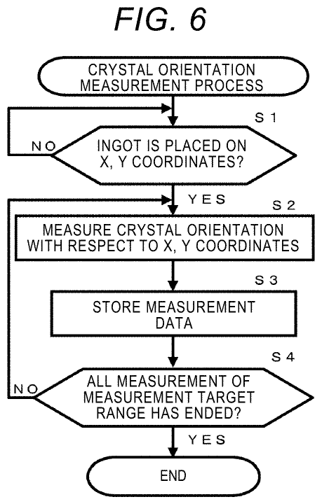

Next, a crystal orientation measurement process according to the embodiment of the present disclosure will be explained. FIG. 6 is a flowchart showing the crystal orientation measurement process according to the embodiment of the present disclosure. The crystal orientation measurement process is executed by the above-described crystal orientation measurement controller 122 of the crystal orientation measurement unit 120.

First, the crystal orientation measurement controller 122 determines whether the ingot (workpiece) 301 as a measurement target is placed on X, Y coordinates or not in Step S1. When the ingot 301 is not placed on X, Y coordinates, the process is repeated.

Next, the crystal orientation measurement controller 122 measures a crystal orientation of the ingot 301 with respect to X, Y coordinates in Step S2.

Next, the crystal orientation measurement controller 122 stores measured crystal orientation data in the data storage section 123 in Step S3.

Next, the crystal orientation measurement controller 122 determines whether all measurement of the entire measurement target range with respect to the ingot 301 as the measurement target has ended or not in Step S4. When it is determined that all measurement of the entire measurement target range has not ended, the process proceeds to Step S2 and the processes of Step S2 and Step S3 are repeated. When it is determined that all measurement of the entire measurement target range has ended, the crystal orientation measurement process is ended.

### (Laser Processing Process)

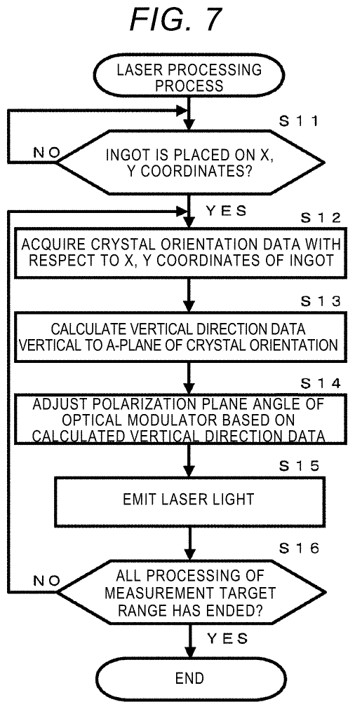

Next, a laser processing process according to the embodiment of the present disclosure will be explained. FIG. 7 is a flowchart showing the laser processing process according to the embodiment of the present disclosure. The laser processing process is executed by the above-described laser processing controller 111.

First, the laser processing controller 111 determines whether the ingot (workpiece) 301 as the processing target is placed on X, Y coordinates (fixed by the fixing jig 107) or not in Step S11. When the ingot is not placed on X, Y coordinates, the process is repeated.

Next, the laser processing controller 111 acquires crystal orientation measurement data of the ingot 301 as the processing target from the above-described data storage section 123 of the crystal orientation measurement controller 122 in Step S12. In this process, the laser processing controller 111 transmits a request for orientation measurement data including ingot identification data capable of identifying the ingot 301 as the processing target of this time to the crystal orientation measurement controller 122. The crystal orientation measurement controller 122 which has received the request extracts crystal orientation measurement data identified by the ingot identification data from respective crystal orientation measurement data stored in the data storage section 123 and transmits the data to the laser processing controller 111.

Next, the laser processing controller 111 calculates vertical direction data with respect to an A-plane of the crystal orientation with respect to X, Y coordinates on the surface of the ingot 301 as the processing target from the acquired crystal orientation measurement data in Step S13.

Next, the laser processing controller 111 adjusts the polarization direction of laser light by controlling the angle of the polarization plane of the polarization plane adjustment unit 102 so that a scanning direction of laser to be applied is a vertical direction with respect to the A-plane of the crystal orientation on the surface of the ingot 301 based on the calculated vertical direction data in Step S14.

Next, the laser processing controller 111 allows laser light to oscillate (be emitted) from the laser oscillator 101 in Step S15. Accordingly, laser processing by the laser light condensed inside the crystal of the ingot 301 is executed.

Next, the laser processing controller 111 determines whether all laser processing in the entire processing target range with respect to the ingot 301 as the processing target has ended or not in Step S16. When it is determined that the laser processing of the entire processing target range has not ended, the process proceeds to Step S12 and processes from Step S12 to Step S15 are repeated. When it is determined that the laser processing of the entire processing target range has ended, the laser processing process is ended.

Although crystal orientation data is acquired from the crystal orientation measurement unit 120 in the above-described Step S12 in the laser processing process, the process is not limited to this. It is also possible to register crystal orientation data previously measured and stored by a crystal orientation measurement device (not shown) provided with the crystal orientation measurement unit 120 in the laser processing controller 111 manually by an operator and the like or automatically to thereby perform the similar laser processing process by using the registered crystal orientation data.

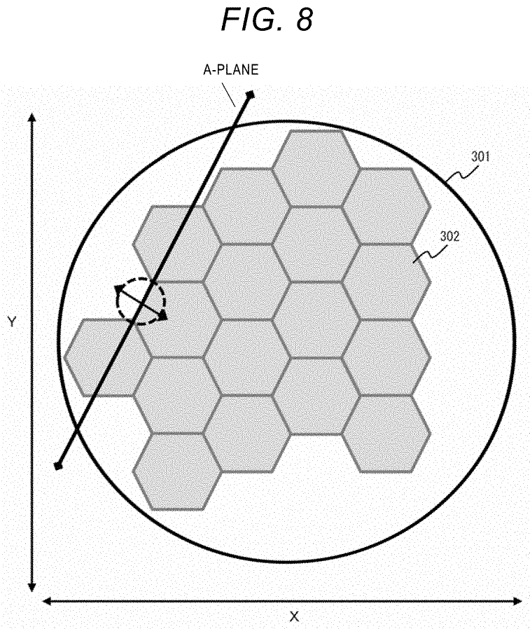

The scanning direction of laser light with respect to the A-plane of the crystal orientation on the surface of the ingot 301 in the case where the above laser processing process is performed will be explained. FIG. 8 is a view showing an image of the scanning direction of laser light with respect to an A-plane of the crystal orientation according to the embodiment of the present disclosure.

As shown in the drawing, vertical direction data with respect to the A-plane of the crystal orientation with respect to X, Y coordinates on the surface of the ingot 301 is calculated by the laser processing controller 111 based on the measured crystal orientation data of the ingot 301 as the laser processing target with respect to X, Y coordinates. Then, laser light is condensed inside the crystal of the ingot 301 to perform laser processing while adjusting the polarization plane with time by the polarization plane adjustment unit 102 so that the calculated vertical direction data corresponds to the scanning direction of laser light, namely, so that the polarization direction of laser light is vertical to the A-plane of the crystal orientation.

Here, the surface of the ingot 301 is irradiated with laser light having a laser wavelength of 1100 nm or less, a pulse width of 1 fsec or more to 1 nsec or less, a frequency of 2 MHz or less, in which an NA of the condensing lens is 0.4 or more to 0.95 or less and a pitch between pulses and a pitch between lines are equal to or less than a condensing light spot diameter.

A thickness and a diameter of the ingot 301 are not particularly limited as far as the thickness is 50 mm or more to 10 mm or less, and the diameter is 100 mm or less. The ingot 301 is not limited to GaN as far as a material is capable of forming the modified layer thereinside.

The laser light oscillating from the laser oscillator 101 is not limited as far as the wavelength is in a range from 100 nm or more to 1000 nm or less. However, a thermal effect can be reduced when the spot diameter at the time of condensing light is small; therefore, it is desirable that the wavelength of laser light is short. It is preferable that the pulse width of laser light is in a range of 50 ps or less, in which internal processing by multiphoton absorption is possible.

Concerning a repeat frequency, it is preferable that the repeat frequency is high when considering productivity. The well-balanced repeat frequency is preferably applied within a range of 1 Hz or more to 5 MHz or less.

It is also preferable that the condensing lens 106 has a numerical aperture (NA) of 0.1 or more to 0.95 or less with respect to the wavelength of laser light.

The aberration correction function is a function capable of suppressing extension of laser light to an incident direction at a condensing point due to a spherical aberration of the lens. It is preferable that the aberration correction function is provided as an energy density of the laser light at the condensing point can be increased. An aberration correction method is not particularly limited, and a method of using the lens with the aberration correction collar as in the condensing lens according to the embodiment, and a method of using a phase modulating element may be applied.

In the laser processing method, the XY stage 110 is moved in an X-axis direction and/or a Y-axis direction while irradiating the inside of the crystal of the ingot 301 with laser light, and laser processing is applied to the entire surface of the ingot 301 while adjusting the polarization direction of laser light by the polarization plane adjustment unit 102 so that the scanning direction of laser light is the vertical direction to the A-plane direction of the crystal 302 on the surface of the ingot 301.

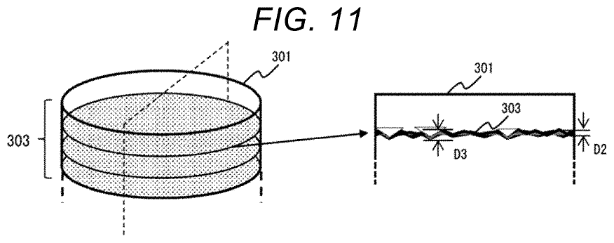

FIG. 11 is a view showing a formation state of the modified layer after the laser processing. FIG. 11 shows a modified layer 303 formed inside the crystal of the ingot 301 by irradiation of laser light from the surface of the ingot 301, and a cross section of the modified layer 303 formed inside the crystal of the ingot 301.

The modified layer 303 in which a width of the modified layer is D2 and a positional variation width of the modified layer is D3 is formed inside the ingot 301 by the laser processing. When the ingot 301 is sliced by using the modified layer 303 as a separation surface, wafers (for example, GaN wafers) are fabricated.

According to the laser processing method, the modified layer 303 is formed without occurrence of a crack or a break on the ingot 301 shown in FIG. 11. The width D2 of the modified layer in this case is 8 to 15 μm and the positional variation width of the modified layer D3 is 3 to 5 μm.

As a result of performing laser processing by using the above related-art laser processing 901 without considering the crystal orientation of the ingot 301 and the polarization plane of laser light, the width D2 of the modified layer in this case is 12 to 25 μm and the positional variation width of the modification layer D3 is 5 to 10 μm.

### Other Embodiments

The laser processing can be performed in consideration of movement in a rotation axis direction by the rotation stage 108 in addition to the above-described movement in the X-axis direction and/or the Y-axis direction by the XY stage 110 according to the embodiment.

### (Other Scanning Method of Laser Light)

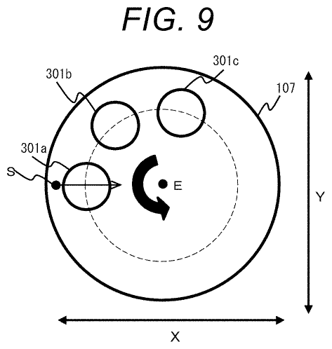

FIG. 9 is a view showing a scanning method of laser light by the laser processing device according to another embodiment of the present disclosure. As shown in the drawing, respective plural ingots 301a, 301b, 301c . . . arranged on a circumference are linearly scanned with laser light by using the XY stage 110 and the rotation stage 108 in the embodiment. In such case, scanning is performed with laser light toward a central direction of the fixing jib 107 by linearly moving the ingots in the X-axis direction and/or the Y-axis direction by the XY stage 110 while rotating the ingots in the rotation axis direction by the rotating stage 108.

In the case where laser processing is performed while the inside of the crystal of the ingot 301 is irradiated with laser light by performing scanning of the ingot 301 with laser light so that a scanning speed, namely, a linear speed is constant in the X-axis direction and/or the Y-axis direction and the rotation axis direction, laser processing is performed to the ingot 301 while adjusting the polarization direction of laser light with time by the polarization plane adjustment unit 102 so that the scanning direction of laser is vertical to the A-plane direction of the crystal 302 on the surface of the ingot 301.

Accordingly, the laser processing is performed while continuously adjusting the polarization plane of laser light by the polarization plane adjustment unit 102 with respect to the movement in the X-axis direction and/or the Y-axis direction by the XY stage 110 and the movement in the rotation axis direction by the rotation stage 108.

At this time, the laser processing controller 111 performs cooperative control of the XY stage 110 and the rotation stage 108 so that the scanning speed, namely, the linear speed is constant at the condensing point of laser light, thereby applying pulses of laser light at equal intervals. Other points are the same as the above contents described with reference to FIG. 5.

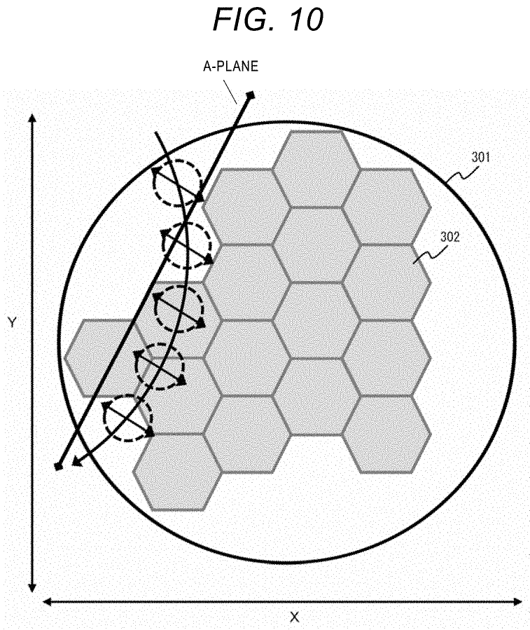

FIG. 10 is a view showing an image of a scanning direction of laser irradiation with respect to the A-plane of the crystal orientation on the surface of the ingot 301 according to another embodiment of the present disclosure.

Also in another embodiment, vertical direction data with respect to A-plane of the crystal orientation with respect to X, Y coordinates of the ingot 301 is calculated by the laser processing controller 111 based on measured crystal orientation data of the ingot 301 as a laser processing target with respect to X, Y coordinates in the same manner as the above embodiment. Then, laser light is condensed inside the crystal of the ingot 301 to perform laser processing while adjusting the polarization plane with time by the polarization plane adjustment unit 102 so that the calculated vertical direction data corresponds to the scanning direction of laser light, namely, so that the polarization direction of laser light is vertical to A-plane of the crystal orientation on the surface of the ingot 301.

Here, the surface of the ingot 301 is irradiated with laser light having the laser wavelength of 1100 nm or less, the pulse width of 1 fsec or more to 1 nsec or less, the frequency of 2 MHz or less, in which the NA of the condensing lens is 0.4 or more to 0.95 or less and the pitch between pulses and the pitch between lines are equal to or less than the condensing light spot diameter in the same manner as the above embodiment.

According to the above laser processing method, the modified layer 303 is formed in the ingot 301 shown in FIG. 11 without occurrence of a crack or a break. The width D2 of the modified layer in this case is 8 to 12 μm, and the positional variation with of the modified layer D3 is 3 to 5 μm.

In the embodiments of the present disclosure, laser processing is performed to the entire measurement range in the ingot 301. In a case where the ingot 301 as the measurement target is a single crystal, the A-plane direction of the crystal 302 can be considered to be approximately constant in the entire measurement range of the ingot 301. On the other hand, in a case where the ingot 301 is a polycrystal, the A-plane directions of the crystal 302 differ according to crystals in the entire measurement range of the ingot 301.

Accordingly, in the embodiments of the present disclosure, laser processing is performed to the entire surface of the ingot 301 while adjusting the polarization direction of laser light with time so that the scanning direction of laser light, namely, the polarization direction of laser light is vertical to the A-plane direction of the crystal 302 on the surface of the ingot 301 irradiated with laser light.

As described above, the modified layer with a reduced width as compared with related art can be formed inside a hard brittle material by using laser light as well as the positional variation width of the modified layer can be suppressed. Accordingly, time efficiency of rough polishing on the surface can be improved, which improves manufacturing efficiency of wafers.

What is claimed is:

1. A laser processing device performing processing of a workpiece by applying condensed laser light, the laser processing device comprising:
a polarization plane adjustment unit configured to adjust a polarization plane of the laser light; and
a vertical direction specifying unit configured to specify a vertical direction with respect to an A-plane of a crystal orientation of the workpiece,
wherein the polarization plane adjustment unit adjusts a polarization direction of the laser light so that scanning of laser light is performed along the specified vertical direction with respect to the A-plane of the crystal orientation of the workpiece.

2. The laser processing device according to claim 1, further comprising:
a crystal orientation measurement unit configured to measure the crystal orientation of the workpiece,
wherein the vertical direction specifying unit specifies the vertical direction with respect to the A-plane of the crystal orientation of the workpiece based on the crystal orientation of the workpiece measured by the crystal orientation measurement unit.

3. The laser processing device according to claim 2,
wherein the crystal orientation measurement unit measures the crystal orientation on a surface of the workpiece irradiated with the laser light.

4. The laser processing device according to claim 1,
wherein the laser light has a wavelength of 1100 nm or less, a pulse width of 1 fsec or more to 1 nsec or less, a frequency of 2 MHz or less, and
a numerical aperture of a lens for condensing laser light is 0.4 or more to 0.95 or less.

5. The laser processing device according to claim 1,
wherein gallium nitride is processed as the workpiece.

6. A laser processing method performing processing of a workpiece by applying condensed laser light, the method comprising:
adjusting a polarization plane of the laser light; and
specifying a vertical direction with respect to an A-plane of a crystal orientation of the workpiece,
wherein, the adjusting of the polarization plane further includes adjusting a polarization direction of the laser light so that scanning of laser light is performed along the specified vertical direction with respect to the A-plane of the crystal orientation of the workpiece.

7. The laser processing method according to claim 6, further comprising:
measuring the crystal orientation of the workpiece,
wherein the specifying of the vertical direction further includes specifying the vertical direction with respect to the A-plane of the crystal orientation of the workpiece based on the measured crystal orientation of the workpiece.
